(19) United States
(12) Patent Application Publication
(10) Pub. No.: US 2025/0318460 A1
(43) Pub. Date: Oct. 16, 2025

(54) ELECTRIC MOWING VEHICLE

(71) Applicant: KANZAKI KOKYUKOKI MFG. CO., LTD., Amagasaki-shi (JP)

(72) Inventors: Koji KIYOOKA, Amagasaki-shi (JP); Takashi NISHIZAWA, Amagasaki-shi (JP); Jun MATSUURA, Amagasaki-shi (JP)

(21) Appl. No.: 19/175,434

(22) Filed: Apr. 10, 2025

(30) Foreign Application Priority Data
Apr. 11, 2024 (JP) 2024-063917

(51) Int. Cl. A01D 34/00; A01D 34/66; A01D 101/00

(52) U.S. Cl. CPC A01D 34/008; A01D 34/66; A01D 2101/00

(57) ABSTRACT

[Problem] To provide a mowing vehicle capable of efficiently carrying out mowing work by suppressing the grass from being left unmown in an early stage even when a high load acts on a mowing motor. [Solution] The mowing vehicle includes a mowing machine. The mowing machine includes mowing blades driven by a mowing motor. When detected that a load of the mowing motor is high, the controller controls to operate the mowing motor with high load according to the high-load-adaptive power map. The high-load-adaptive power map is defined such that a boundary rotation speed, when switching from an upper-limit torque constant region to an upper-limit torque decrease region, is lower than the upper-limit rotation speed of the upper-limit torque constant region in a power characteristic of the mowing motor determined by the mowing motor and the maximum voltage applied on the mowing motor.

### CROSS REFERENCE TO RELATED APPLICATIONS

The present invention claims priority under 35 U.S.C. § 119 to Japanese Application No. 2024-063917, filed on Apr. 11, 2024, the entire contents of which being incorporated herein by reference.

### TECHNICAL FIELD

The present invention relates to an electric mowing vehicle.

### BACKGROUND ART

Conventionally, in a mowing vehicle such as a lawn mowing vehicle equipped with a mowing machine such as a lawn mowing device, a configuration in which a plurality of mowing blades is driven by a plurality of mowing motors, which are electric motors, and mowing work is performed by the plurality of mowing blades, has been known.

Patent Document 1 discloses a configuration in a lawn mowing vehicle equipped with a mower unit (lawn mower), in which lawn mowing work is performed by a plurality of lawn mowing blades driven by a plurality of blade motors (mowing motors). In this configuration, the temperature of the blade motor is detected, and when the detected temperature is higher than a threshold value, the blade motor is controlled by an exceptional speed control to cause the vehicle to travel at an exceptional speed lower than a target traveling speed. The exceptional speed control causes the vehicle to travel at the exceptional speed, which is lower than the target traveling speed determined by the operation amount of a steering lever.

### PRIOR ART DOCUMENT

### Patent Document

Patent Document 1: Japanese Patent Laid-open Publication No. 2014-195360

### SUMMARY OF INVENTION

### Technical Problem

In a grassland, it is often the case that mowing loads acting on respective mowing motors are not equal to each other due to a difference in species or densities of plants planted in the grass field. As a result, there may be a situation where an excessive load acts on one mowing motor as compared with another motor.

In the case where a riding type vehicle equipped with a mowing machine having a plurality of mowing blades, each of which is driven by an electric motor, experiences an excessive load on some of the plurality of mowing motors, if the load exceeds the torque that the mowing motor can possibly output, only the mowing motor on which a high load acts may suddenly enter a stall state and stop. In the event that the mowing motor is completely stopped, the grasses corresponding to the distance over which the vehicle travels for work with the mowing motor being stopped, are left unmown. When the driver notices it, he/she has to make the vehicle perform a U-turn, return to the unmown place, and continue the work.

In particular, since the operating noise of the mowing motor, which is an electric motor, is small, if only a part of the plurality of mowing motors stops, the driver is unlikely to notice the event of the stoppage.

In the case of the configuration disclosed in Patent Document 1, there is a possibility that the rotation speed of the blade motor is changed when the temperature of the blade motor exceeds the threshold value. However, even when the temperature does not exceed the threshold value, the mowing motor on which a high load is acting may suddenly stop, and thus there is still a possibility that the grass will be left unmown.

An object of the present invention is to make it easy for a driver to grasp a situation in which a high load acts on a mowing motor in a mowing vehicle equipped with a mowing machine having a plurality of mowing blades that are electrically driven. Another object of the present invention is to make the mowing motor resistant to a high load to prevent sudden stoppages. Still another object of the present invention is to provide a mowing vehicle capable of suppressing the grass from being left unmown, escaping from a high-load state at an early stage, and efficiently performing mowing work.

### Solution to Problem

In a first aspect of the present invention, an electric mowing vehicle includes: a mowing machine; and a controller, wherein the mowing machine includes: a plurality of mowing motors that are electric motors for mowing; and mowing blades driven by each of the plurality of mowing motors, the controller executes a high-load-adaptive control so as to cause a mowing motor on which a high load acts to operate in accordance with a high-load-adaptive power map that is a power map defining a relationship between an upper-limit torque value that can be output by the mowing motor and a rotation speed of the mowing motor when it is detected that a load of at least one of the plurality of mowing motors is high, and a boundary rotation speed of the mowing motor in the high-load-adaptive power map, at a time when switching from upper-limit torque constant region in which the upper-limit torque value is constant regardless of the rotation speed of the mowing motor to an upper-limit torque decrease region in which the upper-limit torque value decreases in accordance with an increase in the rotation speed of the mowing motor, is defined so as to be lower than an upper-limit rotation speed of the upper-limit torque constant region in a power characteristic of the mowing motor that is determined from a type of the mowing motor and a maximum voltage that can be applied to the mowing motor in a case where the high-load-adaptive control is not executed.

According to the electric mowing vehicle of the present invention, when the load on at least one of the plurality of mowing motors driven at the rated rotation speed is high, the torque of the mowing motor on which the high load acts increases to balance with the load, but the rotation speed decreases in accordance with the upper-limit torque decrease region of the high-load-adaptive power map. Thus, as compared with a conventional case without using the high-load-adaptive power map, since the time interval from when the rotation speed of the mowing motor decreases to when the mowing motor stalls according to the high-load-adaptive power map is longer even under a high load, the driver of the vehicle can easily notice that a high load is acting on the mowing motor from a change in the sound from the mowing machine. As a result, the high load on the mowing motor can be easily eliminated at an early stage by decreasing the traveling speed of the vehicle using the vehicle speed instruction tool, such as the operation lever, for the driver to adjust the traveling speed of the vehicle. Even if a high load is generated in the mowing motor, there is a time margin until the torque of the mowing motor reaches the upper-limit torque constant region, and furthermore, by allowing an increase in torque, a situation where the mowing motor enters a stall state and suddenly stops is less likely to occur. Therefore, the mowing work can be efficiently performed by immediately suppressing the mowing work from being continued with the grass left unmown.

In a preferable embodiment of the electric mowing vehicle according to the present invention, the boundary rotation speed may be set to be substantially equal to the minimum rotation speed of the mowing motor that is required for mowing work using the mowing blades.

According to the above-mentioned configuration, when a high load acts on the mowing motor, the rotation speed of the mowing motor can decrease to a lower speed. Therefore, the driver of the vehicle can more easily notice that the load on the mowing motor is increasing. As a result, the mowing work can be performed more efficiently.

In a preferable embodiment of the electric mowing vehicle according to the present invention, the lower-limit torque of the upper-limit torque decrease region may be 65% or more and 75% or less of the torque value of the upper-limit torque constant region.

According to the above-mentioned configuration, the relationship between the upper-limit torque and the rotation speed of the mowing motor in accordance with the high-load-adaptive power map can be brought close to the relationship between engine torque and engine rotation speed in the case where the mowing machine is driven by the conventional power of the engine. Thus, the driver, who changes from the conventional mowing vehicle in which the mowing machine is driven by the conventional power of the engine, is less likely to feel discomfort.

In a preferable embodiment of the electric mowing vehicle according to the present invention, the controller may detect that the load on the mowing motor is high when the detected torque in accordance with the rotation speed of at least one mowing motor exceeds the upper-limit torque corresponding to the rotation speed of the mowing motor in the high-load-adaptive power map.

Furthermore, in a preferable embodiment of the electric mowing vehicle according to the present invention, when a high load acts on a part of the plurality of mowing motors, the controller may cause the torque of the mowing motor to increase and cause the rotation speed of the mowing motor to decrease according to the high-load-adaptive power map, and the controller may cause the rotation speeds of the remaining mowing motors on which the high load does not act to match the rotation speed of the mowing motor on which the high load acts.

According to the above-mentioned configuration, when a high load acts on some of the plurality of mowing motors, the mowing traces are made uniform and the appearance is improved as compared with a case where the rotation speeds of some of the plurality of mowing motors, for example, the rotation speed of only one mowing motor, decreases.

Furthermore, in a preferable embodiment of the electric mowing vehicle according to the present invention, the electric mowing vehicle may further include: a traveling motor to drive a wheel; and an operation tool for instructing a target rotation speed of the traveling motor by an operation position, wherein the controller may control the driving of the traveling motor in accordance with the target rotation speed, and when it is detected that the load on at least one of the plurality of mowing motors is high, the controller may cause the torque of the mowing motor to increase and cause the rotation speed of the mowing motor to decrease in accordance with the high-load-adaptive power map, and the controller may cause the degree of increase in the target rotation speed of the traveling motor in accordance with a change in the operation position to decrease in accordance with the rate of decrease in the rotation speed of the mowing motor on which the high load acts.

According to the above-mentioned configuration, when a high load is generated in at least one of the plurality of mowing motors, the rotation speed of the mowing motor decreases in accordance with an increase in the load on the mowing motor according to the high-load-adaptive power map, and the traveling speed of the vehicle also decreases. Thus, the driver can notice more quickly that the high load state is generated in the mowing motor. As a result, the mowing work can be more efficiently performed by further suppressing the mowing work from being continued with the grass left unmown. In addition, since the amount of grass allocated to the mowing motor relatively decreases, a state where a high load acts on the mowing motor can be eliminated early.

Furthermore, in a preferable embodiment of the electric mowing vehicle according to the present invention, when the state changes from a state where a high load acts on at least one of the plurality of mowing motors to a state where a high load acts on none of the plurality of mowing motors, the controller may cause the rotation speeds of all of the mowing motors to return to normal rotation speeds and cause the degree of increase in the target rotation speed of the traveling motor corresponding to the change in the operation position of the operation tool to return to a normal degree.

According to the above-mentioned configuration, it is possible to provide the electric mowing vehicle which is easy and efficient to drive for a driver with an operation feeling similar to that in a case where a high load on a mowing machine is eliminated in an engine-type mowing vehicle in which the wheels and the mowing machine are driven by the power of an engine.

### Advantageous Effects of Invention

According to the electric mowing vehicle of the present invention, even when a high load acts on the mowing motor, it is possible to efficiently perform mowing work by preventing a sudden stoppage of the mowing motor from occurring.

### BRIEF DESCRIPTION OF DRAWINGS

FIG. 1 is a perspective view of an electric mowing vehicle according to an embodiment of the present invention;

FIG. 2 is a schematic top view of the electric mowing vehicle of FIG. 1;

FIG. 3A is a block diagram showing a control system of the electric mowing vehicle of FIG. 1;

FIG. 3B is a block diagram showing in detail a control configuration of a plurality of deck motors which are a part of FIG. 3A;

FIG. 4 is a diagram showing a relationship between a power characteristic of a deck motor, which is a mowing motor, in a high-load-adaptive power map according to the embodiment and a conventional power characteristic of a deck motor without executing a high-load-adaptive control;

FIG. 5 is a diagram showing an example of a relationship between an operation amount of left and right operation levers toward a front side and a rotation speed of a traveling motor on the same side as the operation levers with respect to a left-right direction according to the embodiment;

FIG. 6 is a flowchart showing an example of a method of controlling the deck motors according to the embodiment;

FIG. 7 is a block diagram showing a control configuration of a plurality of deck motors of the electric mowing vehicle according to an alternative embodiment of the present invention, which corresponds to FIG. 3B;

FIG. 8 is a flowchart showing an example of a method of controlling the deck motors according to the alternative embodiment; and

FIG. 9 is a diagram showing a part of processing of a plurality of deck inverter controllers when causing the plurality of deck inverter controllers to execute a control processing of FIG. 8.

### DESCRIPTION OF EMBODIMENTS

Now, an embodiment of the present invention will be described below in detail with reference to the drawings. Hereinafter, a case where an electric mowing vehicle is a lawn mowing vehicle equipped with a lawn mower as a mowing machine is described, but the electric mowing vehicle may be a mowing vehicle equipped with a mowing machine for mowing weeds other than lawn grasses. Furthermore, hereinafter, a case where the lawn mower is provided between the front wheels and rear wheels is described, but the mowing machine may be a vehicle equipped with the mowing machine in front of the front wheels. Furthermore, hereinafter, a case where a vehicle in which two motors drive two rear wheels is described, but the vehicle may be configured so that two motors drive two front wheels. Furthermore, hereinafter, a case where a left-and-right lever-type operation unit having two left and right operation levers is used is described, but this is merely illustrative. A steering wheel may be used as a turn instruction tool, and an accelerator pedal provided in front of a seat may be used as a travel instruction tool. In the following, the same components are denoted by identical reference numerals throughout the drawings, and duplicated explanations are omitted or simplified.

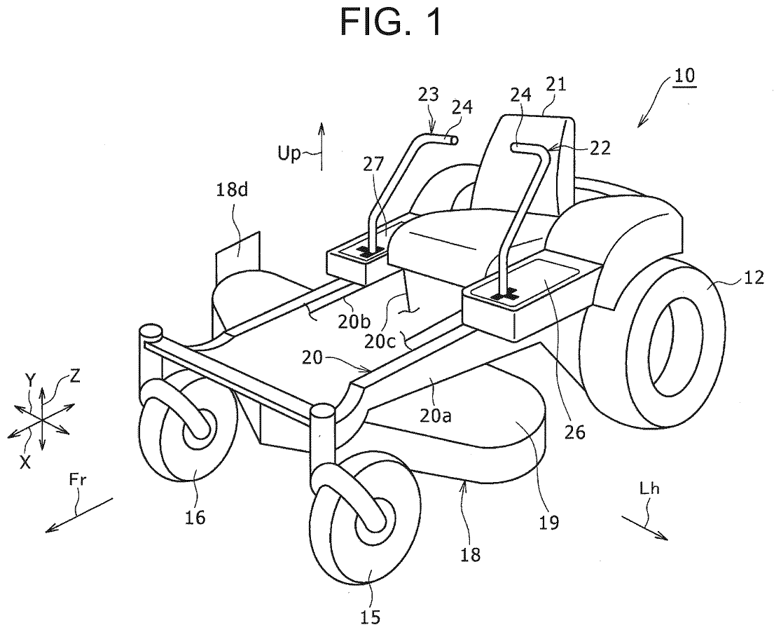

FIG. 1 to FIG. 7 show an embodiment. Throughout the drawings referred to below, the front-rear direction is denoted by “X”, the left-right direction is denoted by “Y”, and the up-down direction is denoted by “Z”. In addition, the front side is denoted by “Fr”, the left side is denoted by “Lh”, and the upper side is denoted by “Up”. The directions X, Y, and Z are orthogonal to each other.

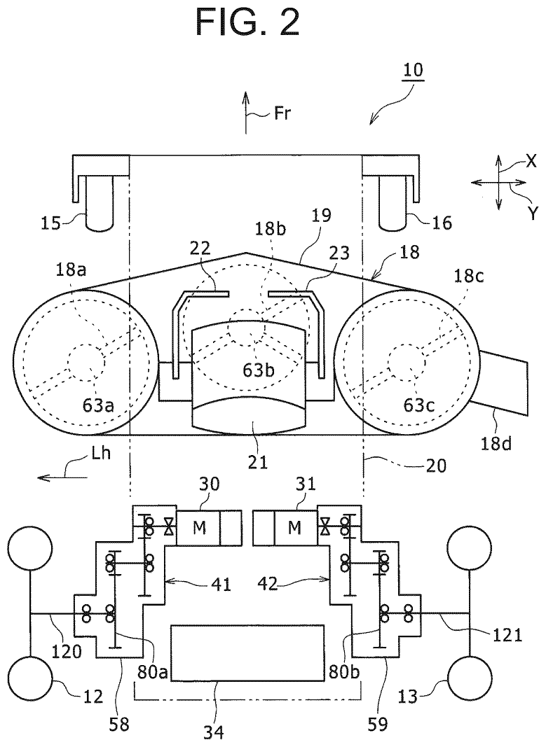

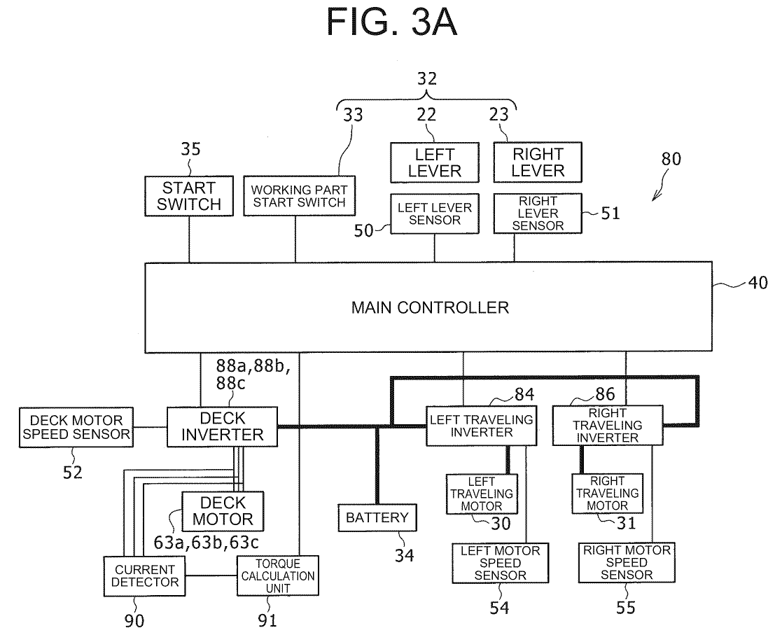

FIG. 1 is a perspective view of an electric mowing vehicle 10 according to the embodiment. FIG. 2 is a schematic configuration diagram of the electric mowing vehicle 10. FIG. 3A is a block diagram showing a control system 80 of the electric mowing vehicle 10. In the following description, the electric mowing vehicle 10 is simply referred to as “vehicle 10”. The vehicle 10 is a riding autonomous lawn mowing vehicle suitable for lawn mowing. The vehicle 10 includes a left wheel 12 and a right wheel 13 (see FIG. 2), caster wheels 15 and 16, which are two left and right front wheels, and a lawn mower 18, which is a mowing machine. Furthermore, the vehicle 10 includes a left traveling motor 30 and a right traveling motor 31 (see FIG. 2 and FIG. 3A) for driving the left and right wheels 12 and 13. Furthermore, the vehicle 10 includes three deck motors 63a, 63b, and 63c (see FIG. 2), which are mowing motors, two left and right operation levers 22 and 23, a battery 34 (see FIG. 2 and FIG. 3A), and a main controller 40 (see FIG. 3A). The left traveling motor 30, the right traveling motor 31, and the deck motors 63a, 63b, and 63c each use an electric motor, so that an electric mowing vehicle is configured. Hereinafter, the deck motors 63a, 63b, and 63c may be collectively referred to as deck motor 63.

The left wheel 12 and the right wheel 13 are rear wheels supported at both the left and right sides in the rear of a main frame 20, which is a vehicle body, and serve as main drive wheels. The main frame 20 is made of metal such as steel and formed into a beam structure or the like. The main frame 20 includes side plate portions 20a and 20b, which extend substantially in a front-rear direction at both the left and right ends, and a coupling portion 20c, which couples the left and right side plate portions 20a and 20b. A driver's seat 21, on which a driver as a user sits, is fixed at the upper side between the rear end portions of the left and right side plate portions 20a and 20b.

The left and right operation levers 22 and 23 are arranged separately on the left and right sides of the driver's seat 21, respectively, and each of the left and right operation levers 22 and 23 instructs the rotation direction and rotation speed of the left and right wheels 12 and 13, which correspond to the left and right operation levers 22 and 23, by moving the left and right operation levers 22 and 23 in the front-rear direction. Specifically, in the main frame 20, two guide panels 26 and 27 are fixed at the left and right sides of the driver's seat 21, respectively, and the two left and right operation levers 22 and 23 are supported by the main frame 20 so that the two left and right operation levers 22 and 23 project upward from the two guide panels 26 and 27, respectively. The two left and right operation levers 22 and 23 correspond to a vehicle speed instruction tool for the driver to adjust the traveling speed of the vehicle and correspond to an operation tool to instruct a target rotation speed of the traveling motors 30 and 31 by an operation position.

The left operation lever 22 has a function of instructing acceleration, deceleration, stop, normal rotation, and reverse rotation of the left traveling motor 30. The right operation lever 23 has a function of instructing acceleration, deceleration, stop, normal rotation, and reverse rotation of the right traveling motor 31. The driver grips the tip portions of the left and right operation levers 22 and 23 to instruct the rotation directions and rotation speeds of the left and right wheels 12 and 13. The left operation lever 22 is operated to instruct the drive state of the left wheel 12. The right operation lever 23 is operated to instruct the drive state of the right wheel 13. Each of the left and right operation levers 22 and 23 has substantially an L-shape, so that a gripping portion 24 extending in the left-right direction is formed in the upper end portion. The gripping portion 24 is gripped and operated by the driver. Each of the left and right operation levers 22 and 23 is fixed at the lower end portion so as to swing about a shaft extending in the left-right direction. Each of the left and right operation levers 22 and 23 may be configured to instruct that the traveling motor 30 (or 31) on the same side as the left or right operation lever 22 or 23 is driven at a target rotation speed per unit time (sec\hat{ }−1) as a target rotation speed corresponding to forward traveling when the left or right operation lever 22 or 23 is tilted forward with an N position as a reference, which is a neutral position close to an upright position. A target rotation speed per minute (min\hat{ }−1) may be set as the target rotation speed.

The left and right operation levers 22 and 23 instruct that the more the amount of inclination of the levers increases, the more the target rotation speed increases. When the left and right operation levers 22 and 23 are tilted to the rear side with the N position as a reference, the operation levers 22 and 23 instruct that the traveling motor 30 (or 31) on the same side as the left or right operation lever 22 (or 23) is driven at a target rotation speed corresponding to backward movement, and instruct that the more the amount of inclination of the levers increases, the more the target rotation speed increases. When the left and right operation levers 22 and 23 are moved to the N position, the left or right operation lever 22 (or 23) instructs that the traveling motor 30 (or 31) on the same side as the left or right operation lever 22 (or 23) stops driving. Thus, each of the left and right operation levers 22 and 23 instructs the target rotation speed of the traveling motors 30 and 31 corresponding to the left and right operation levers 22 and 23 by the operation of the user, thereby instructing the forward movement, the backward movement, and the stoppage of the vehicle.

The tilted positions of the two left and right operation levers 22 and 23 in the front-rear direction are detected by left and right lever position sensors (not shown), respectively. The lever position sensors each include a potentiometer, for example. A detection signal from each of the lever position sensors is transmitted to the main controller 40 (see FIG. 3A).

The two left and right caster wheels 15 and 16 are steered wheels supported on the front end portion of the main frame 20 and also serve as front wheels. The caster wheels 15 and 16 are provided so as to be spaced apart from the left wheel 12 and the right wheel 13 in the front-rear direction of the vehicle 10, respectively. Each of the caster wheels 15 and 16 is capable of free rotation of 360 degrees or more about a shaft extending in the vertical direction (up-down direction shown in FIG. 1). Note that the caster wheels are not limited to such a configuration where two caster wheels are arranged on the vehicle, and only one caster wheel or three or more caster wheels may be arranged on the vehicle.

As shown in FIG. 2, the left traveling motor 30 is connected to the left wheel 12 via a left gear mechanism 80a supported on the rear side of the main frame 20 and a left axle 120. The right traveling motor 31 is connected to the right wheel 13 via a right gear mechanism 80b supported on the rear side of the main frame 20 and a right axle 121. The left traveling motor 30 and the right traveling motor 31 are supported at the left side and the right side, respectively, on the rear side of the main frame 20. The driving of each of the traveling motors 30 and 31 is controlled by the main controller 40 in accordance with the operation of the corresponding operation levers 22 and 23. Thus, the two left and right traveling motors 30 and 31 are coupled to the two left and right wheels 12 and 13, respectively, and driven separately from each other. Furthermore, the left traveling motor 30 drives the left wheel 12, and the right traveling motor 31 drives the right wheel 13.

A battery 34 (see FIG. 2) is connected to the left traveling motor 30 via a left traveling inverter 84, and electric power is supplied from the battery 34 to the left traveling motor 30. The battery 34 is connected to the right traveling motor 31 via a right traveling inverter 86, and electric power is supplied from the battery 34 to the right traveling motor 31. The left traveling motor 30 and the right traveling motor 31 are three-phase motors, for example. As shown in FIG. 2, at a position behind the driver's seat 21, the battery 34 is fixed to the upper surface side or the lower surface side of the main frame 20.

As shown in FIG. 1 and FIG. 2, the lawn mower 18 is supported by an intermediate portion of the main frame 20 in a longitudinal direction underneath the main frame 20. This allows the lawn mower 18 to be arranged between the caster wheels 15 and 16 and the left and right wheels 12 and 13 in the front-rear direction. The lawn mower 18 includes lawn mowing blades 18a, 18b, and 18c (see FIG. 2), which are three mowing blades serving as lawn mowing rotary tools disposed inside a mower deck 19 serving as a cover. The upper sides of the lawn mowing blades 18a, 18b, and 18c are covered by the mower deck 19. Each of the lawn mowing blades 18a, 18b, and 18c includes a plurality of blade elements that rotate around a shaft directed in the vertical direction (front-back face direction in FIG. 2 as viewed from the paper). This makes it possible for the blade elements to rotate and perform lawn mowing by cutting the lawn. The mown lawn is discharged from a discharge duct 18d provided on one of the left and right sides of the mower deck 19.

Each of the three lawn mowing blades 18a, 18b, and 18c is connected to a corresponding deck motor 63 of the three deck motors 63a, 63b, and 63c serving as mowing motors. A battery 34 is connected to each of the deck motors 63 via deck inverters 88a, 88b, and 88c (see FIG. 3A), which are inverters for the corresponding deck motors 63, and electric power is supplied from the battery 34 to the deck motors 63. The driving of a deck inverter circuit (described later) of each of the deck inverters 88a, 88b, and 88c is controlled by the main controller 40 in response to the operation of the working unit start switch 33. This allows each of the deck motors 63 to be driven. Each of the deck motors 63 is a three-phase motor, for example. Hereinafter, the deck inverters 88a, 88b, and 88c may be collectively referred to as deck inverter 88.

That is an overall configuration of the vehicle 10. Next, a control system 80 of the vehicle, which includes the three deck motors 63 for driving the lawn mower 18 and the main controller 40, will be described with reference to FIG. 3A. The main controller 40 is connected to a start switch 35, a working unit start switch 33, two left and right lever position sensors 50 and 51, two left and right traveling inverters 84 and 86, a deck inverter 88, and two left and right motor speed sensors 54 and 55. The start switch 35 and the working unit start switch 33 are installed on or near one of the guide panels 26 and 27, which guide one of the two left and right operation levers 22 and 23. The start switch 35 is provided so as to be operable by the user, and supplies electric power from the battery 34 to the main controller 40 based on the operation to start the main controller 40. The working unit start switch 33 is provided so as to be operable by the user, and switches between activation and stop of the lawn mower 18 based on the operation. When the start of the lawn mower 18 is instructed by the working unit start switch 33, that is, when the lawn mower 18 is turned on, the main controller 40 controls the deck inverter 88, which is described later, to operate the deck motor 63 such that the deck motor 63 continues to rotate at a rated rotation speed Vr, which is a target rotation speed during standard mowing work.

The control system 80 includes the start switch 35, an operation unit 32 including the working unit start switch 33 and two left and right operation levers 22 and 23, two left and right lever position sensors 50 and 51, two left and right traveling motors 30 and 31, two left and right traveling inverters 84 and 86, two left and right motor speed sensors 54 and 55, three deck motors 63, three deck inverters 88, three deck motor speed sensors 52, a current detector 90 and a torque calculation unit 91 for detecting the torque of each of the deck motors 63, and a main controller 40. Although only one deck motor 63, one deck inverter 88, one deck motor speed sensor 52, and one current detector 90 are shown in FIG. 3A, since three deck motors 63 are actually provided as shown in FIG. 2, three deck inverters 88, three deck motor speed sensors 52, and three current detectors 90 are provided in the control system 80 correspondingly.

The left traveling inverter 84 drives the left traveling motor 30, and the right traveling inverter 86 drives the right traveling motor 31. Each of the traveling inverters 84 and 86 includes, for example, a traveling inverter circuit including three arms, each of which includes two switching elements electrically coupled in series, and a traveling inverter controller to control the traveling inverter circuit.

The operation of each of the traveling inverters 84 and 86 is controlled by the main controller 40. This allows the left traveling motor 30 to be controlled by the main controller 40 via the left traveling inverter 84. The right traveling motor 31 is controlled by the main controller 40 via the right traveling inverter 86.

Furthermore, a detection value of the rotation speed of the left traveling motor 30, which is detected by the left motor speed sensor 54, is input to the left traveling inverter controller of the left traveling inverter 84. A detection value of the rotation speed of the right traveling motor 31, which is detected by the right motor speed sensor 55, is input to the right traveling inverter controller of the right traveling inverter 86. The two left and right motor speed sensors 54 and 55 detect the rotation speeds of the two left and right traveling motors 30 and 31, respectively. The detection values of the rotation speeds, which are detected by each motor speed sensor 54 and 55, are output to the main controller 40.

FIG. 3B is a block diagram showing in detail a control configuration of the three deck motors 63a, 63b, and 63c, which are a part of FIG. 3A. As shown in FIG. 3B, the three deck inverters 88a, 88b, and 88c have deck inverter controllers 92a, 92b, and 92c and deck inverter circuits 93a, 93b, and 93c, respectively.

Each of the deck inverters 88 drives a corresponding one of the deck motors 63. Each of the deck inverter controllers 92a, 92b, and 92c of the deck inverters 88 controls a corresponding one of the deck inverter circuits 93a, 93b, and 93c. The basic configurations of the deck inverter circuits 93a, 93b, and 93c and the deck inverter controllers 92a, 92b, and 92c are the same as those of the traveling inverter circuits and the traveling inverter controllers of the traveling inverters 84 and 86, respectively.

The operation of each of the deck inverters 88 is controlled by the main controller 40 as described later. The detection values of the rotation speeds of the deck motors 63, which are detected by the deck motor speed sensors 52, are respectively input to the deck inverter controllers 92a, 92b, and 92c of the deck inverters 88. Each of the deck motor speed sensors 52 detects the rotation speed of a corresponding one of the deck motors 63. The deck inverter controllers 92a, 92b, and 92c output the detection values of the rotation speeds from the deck motor speed sensors 52 to the main controller 40.

The current detector 90 detects a current flowing from the deck inverter 88 to the deck motor 63. For example, the current detector 90 calculates the current value of the deck motor 63 based on the current value acquired from the three-phase or two-phase wires connecting the coil wire of the three-phase deck motor 63 and the three-phase deck inverter.

The torque calculation unit 91 receives the current value detected by the current detector 90 and calculates the torque of the deck motor 63 from the current value. At this time, the torque can be calculated from the current value by using a map representing the relationship between the current value and the torque or a predetermined calculation formula. This allows the torque of the deck motor 63 to be indirectly detected. The torque of each of the deck motors 63 calculated by the torque calculation unit 91 is output to the main controller 40 as a detected torque of each of the deck motors 63. The main controller 40 may include the function of the torque calculation unit 91.

The main controller 40 detects an operation point of each of the deck motors 63 based on the torque detection values and the detection values of the rotation speeds of the deck motors 63a, 63b, and 63c. The main controller 40 controls each of the deck motors 63 so that each of the deck motors 63 is basically driven at a rated rotation speed, which is a predetermined target rotation speed, as long as at least a part of the deck motors 63 is not in a high-load state. At this time, the deck motors 63 are each controlled by the main controller 40 via the inverter controllers 92a, 92b, and 92c of the deck inverters 88. Therefore, each of the lawn mowing blades 18a, 18b, and 18c is driven to rotate by a corresponding one of the deck motors 63.

Note that a power supply path from the battery 34 is indicated by a thick solid line in FIG. 3A. In addition, a signal transmission path is indicated by a thin solid line in FIG. 3A.

The main controller 40 includes an arithmetic section such as a CPU and a storage section such as a memory, and is constituted by a microcomputer, for example. The main controller 40 acquires the operation positions of the two operation levers 22 and 23 from the detection signals detected by the two left and right lever position sensors 50 and 51, and sets the target rotation speeds of the left traveling motor 30 and the right traveling motor 31 in accordance with the operation positions of the operation levers 22 and 23.

The main controller 40 sets the target rotation speeds of the two left and right traveling motors 30 and 31 in accordance with the operation positions of the two left and right operation levers 22 and 23, whereby the main controller 40 can cause the vehicle to perform straight travel and turning travel. Thus, the main controller 40 controls the driving of the traveling motors 30 and 31 in accordance with the target rotation speeds which are set in accordance with the operation positions of the two left and right operation levers 22 and 23.

Furthermore, when the main controller 40 detects that the load on at least one deck motor 63 of the plurality of deck motors 63 is high, the main controller 40 executes high-load-adaptive control to operate the deck motor 63 with a high load according to the high-load-adaptive power map.

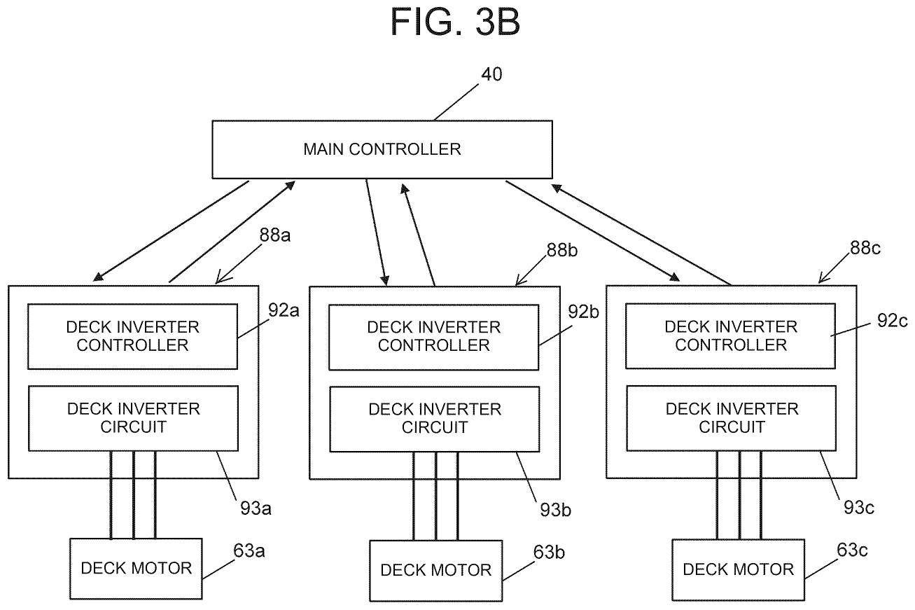

FIG. 4 shows the relationship between the power characteristic of the deck motor 63 in the high-load-adaptive power map and the conventional power characteristic of the deck motor 63 without executing the high-load-adaptive control. The high-load-adaptive power map is a map in which the power characteristic for operating the deck motor 63 is set to suppress a sudden stop of the deck motor 63 when a high load acts on the deck motor 63, and is stored in the storage section of the main controller 40 in advance.

Here, the conventional power characteristic of the deck motor 63 without executing the high-load-adaptive control is represented by a line M1, which consists of a thick solid line portion α2 and thick broken line portions α1 and β1 in FIG. 4. The line M1 is represented by an upper-limit torque value that the deck motor 63 can output, which is set corresponding to the rotation speed of the deck motor 63. The power characteristic includes upper-limit torque constant regions α1 and α2, and an upper-limit torque decrease region β1, which is connected to an inflection point P1 corresponding to an upper-limit rotation speed of the upper-limit torque constant regions α1 and α2. In the upper-limit torque constant regions α1 and α2, the upper-limit torque value is constant regardless of the rotation speed of the deck motor 63. On the other hand, in the upper-limit torque decrease region β2, the upper-limit torque value decreases linearly as the rotation speed of the deck motor 63 increases. The upper-limit torque constant regions α1 and α2 in the power characteristic are determined by the type of the deck motor 63 and the maximum voltage that can be applied to the deck motor 63 from the battery 34, which is a power source, via the deck inverter 88. Therefore, the rotation speed V1 at the inflection point P1, which is the upper-limit rotation speed of the upper-limit torque constant regions α1 and α2, is also determined by the type of the deck motor 63 and the maximum voltage that can be applied to the deck motor 63 from the battery 34. Note that in the conventional power characteristic, the maximum rotation speed of the deck motor 63 may be set to be not more than the upper-limit rotation speed V1 of the upper-limit torque constant regions α1 and α2, in which the upper-limit torque value is constant regardless of the rotation speed of the deck motor 63, and the upper-limit torque Tmax may be constantly output from zero speed to the maximum rotation speed.

On the other hand, the power characteristic of the high-load-adaptive power map used in the present embodiment is represented by a line M2 consisting of thick solid line portions α2 and β2 in FIG. 4. Similarly to the line M1, the power characteristic of the present embodiment is also represented by the upper-limit torque value of the deck motor 63, which is set corresponding to the rotation speed of the deck motor 63. The upper-limit torque value in the power characteristic according to the present embodiment includes an upper-limit torque constant region α2 in which the upper-limit torque value provided on the lower rotation speed side is constant as Tmax, and an upper-limit torque decrease region β2 provided on the higher rotation speed side. In the line M2, which represents the power characteristic according to the present embodiment, the upper-limit torque constant region α2 and the upper-limit torque decrease region β2 are switched to each other at an inflection point P2 in accordance with a change in the rotation speed of the deck motor 63. The meanings of the upper-limit torque constant region α2 and the upper-limit torque decrease region B2 are the same as those of the upper-limit torque constant region α1 and the upper-limit torque decrease region β1. In the present embodiment, a boundary rotation speed at the inflection point P2 is defined to be lower than the upper-limit rotation speed V1 at the inflection point P1 of the upper-limit torque constant regions α1 and α2 in the conventional power characteristic. More specifically, the boundary rotation speed at the inflection point P2 is defined to substantially coincide with the minimum rotation speed Vmin of the deck motor 63, which is required for mowing work using the lawn mowing blades 18a, 18b, and 18c. Furthermore, in the power characteristic of the high-load-adaptive power map according to the present embodiment, the lower-limit torque value Tmin of the upper-limit torque decrease region β2 may be between 65% or more and 75% or less of the torque value Tmax of the upper-limit torque constant region α2, and more preferably, may be approximately 70% of the torque value Tmax.

The high-load-adaptive power map of FIG. 4 referred to above is used to operate each of the deck motors 63 according to the power characteristic of the high-load-adaptive power map when a high load acts on the deck motor 63. Specifically, the main controller 40 detects that the load on the deck motor 63 is high in the event where the detected torque value corresponding to the rotation speed of at least one of the deck motors 63 exceeds the upper-limit torque value corresponding to the rotation speed of the deck motor 63 in the high-load-adaptive power map.

For example, as shown in FIG. 4, in the present embodiment, it is assumed that the deck motor 63 rotates at a preset rated rotation speed Vr once the working unit start switch 33 is turned on, and a work load does not act on the deck motor 63 when the vehicle does not enter into a grassland during traveling, for example. In this case, the deck motor 63 is driven at the operation point PA1 with a minimum torque that is required to continuously rotate the lawn mowing blades 18a, 18b, and 18c at the rated rotation speed Vr.

Next, in the case where the amount of grass cut by the lawn mowing blades 18a, 18b, and 18c is standard, the deck motor 63 moves to an operation point PA2 along the arrow a1 and then operates at the operation point PA2. In this case, the deck motor 63 outputs a rated torque value Tr, which is determined by the rated rotation speed Vr, to perform the mowing work. Furthermore, in this state, the amount of torque change up to the upper-limit torque value Tmax is indicated as A2.

Here, for example, when a mowing load increases due to an increase in the amount of grass cut by the lawn mowing blades 18a, 18b, and 18c, the motor torque increases in accordance with the increase of the mowing load and exceeds a torque value corresponding to the rotation speed of the upper-limit torque decrease region β2 of the power characteristic M2, which is the high-load-adaptive power map, and thus it is detected that a high load acts on the deck motor 63. At this time, the rotation speed of the deck motor 63 decreases along the line of the upper-limit torque decrease region β2 of the power characteristic M2, which is the high-load-adaptive power map, in the direction of the arrow a2, and the operation point of the deck motor 63 moves to an operation point PA3 at the upper-limit torque decrease region β2 until the motor torque corresponds to the increased mowing load. As a result, the deck motor 63 operates at the rotation speed V2 lower than the rated rotation speed Vr and the torque T2 higher than the rated torque value Tr, and the mowing work is continued. At this time, the amount of torque change (Tmax−T2) up to the upper-limit torque value Tmax is indicated as A2a, and there still remains a margin up to the upper-limit torque value Tmax.

On the other hand, unlike the embodiment, in the case of the conventional power characteristic M2, which does not use the power characteristic M1 of the high-load-adaptive power map, when the rotation speed of the deck motor 63 is the rated rotation speed Vr, the deck motor 63 is at the operation point PA4 and performs the mowing work with the torque Tra larger than the torque T2. At this time, the amount of torque change (Tmax−Tra) up to the upper-limit torque value Tmax is indicated as A1. If the mowing load increases from this state and the amount of load increase becomes the same as the amount of load increase between the operation points PA2 and PA3, the rotation speed of the deck motor 63 decreases to the vicinity of V1, the torque of the deck motor 63 increases to the vicinity of the upper-limit torque value Tmax, and the amount of torque change up to the upper-limit torque value Tmax becomes substantially zero. Therefore, if the mowing load larger than this acts on the deck motor 63, the deck motor 63 would stall and stop.

In the embodiment, since the time interval from when the rotation speed of the deck motor 63 decreases from the rated rotation speed Vr to when the deck motor 63 stalls is longer, the driver easily feels and notices that the sound of the deck motor 63 of the lawn mower 18 changes and thus a high load is acting on the deck motor 63. In other words, according to the conventional power characteristic map of the conventional deck motor, it is a concern that the driver continues the mowing operation with some grass left unmown without noticing that the deck motor 63 suddenly stops. On the other hand, according to the present embodiment, although the rotation speed of the deck motor 63 on which a high load acts is decreased and the appearance of the mowing is deteriorated, the mowing can be continued. If the driver notices that the sound of the deck motor 63 changes and decreases the mowing load by lowering the traveling speed, the deck motor 63 can be returned to the same set rotation as the other deck motors 63.

Furthermore, in this example, the boundary rotation speed of the inflection point P2 of the high-load-adaptive power map M2 is defined to substantially coincide with the minimum rotation speed Vmin of the deck motor 63, which is required for the mowing work using the lawn mowing blades 18a, 18b, and 18c. Thus, when a high load acts on the deck motor 63, the rotation speed of the deck motor 63 can be decreased to a lower speed. Therefore, the driver of the vehicle can more easily notice that the load on the deck motor 63 is increasing. As a result, the mowing work can be performed more efficiently.

Furthermore, in the power characteristic of the high-load-adaptive power map, when the lower-limit torque Tmin of the upper-limit torque decrease region β2 is set to 65% or more and 75% or less of the torque value Tmax of the upper-limit torque constant region α2, the relationship between the upper-limit torque of the high-load-adaptive power map and the rotation speed of the deck motor 63 can be brought close to the relationship between engine torque and engine rotation speed when the mowing machine is driven by the power of a conventional engine. As a result, the driver, who changes from the conventional mowing vehicle in which the mowing machine is driven by the power of the conventional engine to the electric mowing vehicle according to the present embodiment, is less likely to feel discomfort.

Furthermore, in the present embodiment, when a high load acts on some of the plurality of deck motors 63, the main controller 40 controls so that the torques of some of the deck motors 63 increase and the rotation speeds of some of the deck motors 63 decrease according to the high-load-adaptive power map, and the main controller 40 preferably controls the rotation speeds of the remaining deck motors 63 on which the high load does not act to match the rotation speeds of some of the deck motors 63 on which the high load acts.

As a result, in the present embodiment, when a high load acts on some of the plurality of deck motors 63, for example, on one of the deck motors 63, since the rotation speeds of all of the deck motors 63 are decreased as compared with the case where the rotation speed of only one deck motor 63 is decreased, the mown trace is made uniform and the appearance is improved.

Furthermore, in the present embodiment, when it is detected that the load on at least one of the plurality of deck motors 63 is high, the main controller 40 controls so that the torque of the deck motor 63 increases and the rotation speed of the deck motor 63 decreases according to the high-load-adaptive power map, and the main controller 40 controls to decrease, according to the rate of decrease in the rotation speed of the deck motor 63 on which the high load acts, the degree of increase in the target rotation speed of the traveling motors 30 and 31 in accordance with the change in the operation positions of the left and right operation levers 22 and 23. Thus, as described later, the driver can notice the occurrence of the high load state in the deck motor 63 at an early stage. As a result, the mowing work can be more efficiently performed by further suppressing the mowing work from being continued with the grass left unmown. In addition, since the degree of deceleration of the traveling speed can be minimized and a state where a high load acts on the deck motor 63 can be eliminated early, the work efficiency is improved.

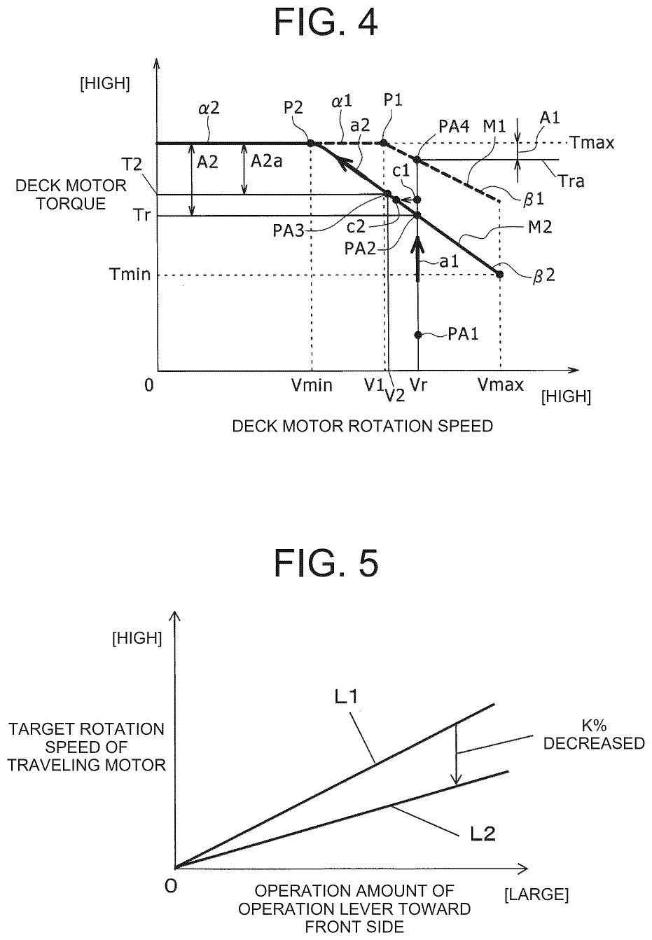

FIG. 5 is a diagram showing an example of a relationship between the operation amount of the left and right operation levers 22 and 23 toward the front side and the rotation speed of the traveling motors 30 and 31 on the same side as the operation levers 22 and 23 with respect to the left-right direction according to the embodiment. L1 shown in FIG. 5 is an operation-lever-and-motor-speed-relation line that represents the relationship between the operation amount of the operation levers 22 and 23 toward the front side and the rotation speed of the traveling motors 30 and 31 when a high load does not act on the deck motor 63. On the other hand, L2 shown in FIG. 5 is an operation-lever-and-motor-speed-relation line that is applied when a high load is detected in the deck motor 63 and the rotation speed of the deck motor 63 is controlled to be decreased in accordance with an increase in the torque of the deck motor 63.

In the example shown in FIG. 5, when the rotation speed of the deck motor 63 on which a high load acts decreases by K % in accordance with the high-load-adaptive power map, the degree of increase in the target rotation speed of the traveling motors 30 and 31 in accordance with the change in the operation positions of the left and right operation levers 22 and 23 is controlled to decrease by K % in accordance with the rate of decrease in the rotation speed of the deck motor 63 on which the high load acts.

Thus, in the present embodiment, when a high load is generated in some of the deck motors 63, the rotation speeds of all of the deck motors 63 are controlled to decrease in accordance with an increase in the load on the deck motor 63 on which the high load acts, and the traveling speed of the vehicle is also controlled to decrease. As a result, the driver is more likely to notice that the high load state occurs in the deck motor 63 at an early stage. As a result, the mowing work can be more efficiently performed by further suppressing the mowing work from being continued with the grass left unmown.

Note that in this example, when a high load is generated in some of the deck motors 63, the rotation speeds of all of the deck motors 63 are controlled to decrease in accordance with an increase in the load on the deck motor 63 on which the high load acts, and the traveling speed of the vehicle is also controlled to decrease. On the other hand, in an alternative example of the present embodiment, when a high load is generated in some of the deck motors 63 and the control is executed so that the torques of some of the deck motors 63 are increased and the rotation speeds of some of the deck motors 63 are decreased according to the high-load-adaptive power map, the control may be executed to either match the rotation speeds of the remaining deck motors 63 on which the high load does not act with the rotation speeds of some of the deck motors 63 on which the high load acts, or to decrease, according to the rate of decrease in the rotation speeds of some of the deck motors 63 on which the high load acts, the degree of increase in the target rotation speeds of the traveling motors 30 and 31 according to the change in the operation positions of the left and right operation levers 22 and 23.

Furthermore, in the present embodiment, when the state changes from a state where a high load acts on at least one of the plurality of deck motors 63 to a state where the high load does not act on any of the deck motors 63, the main controller 40 controls the operation to return the rotation speeds of all of the deck motors 63 to the normal rotation speed, and to return the degree of increase in the target rotation speeds of the traveling motors 30 and 31 according to the change in the operation position of the operation levers 22 and 23 to the normal degree. This configuration allows the driver to easily drive the vehicle with an operation feeling similar to that in a case where the mowing load of the mowing machine is eliminated in the vehicle in which the wheels and the mowing machine are driven by the power of the engine.

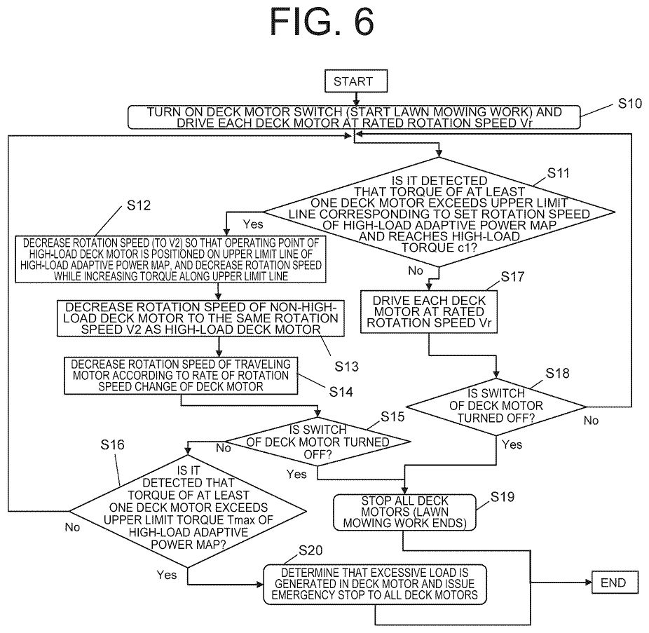

FIG. 6 is a flowchart showing an example of a method of controlling the deck motors 63 according to the present embodiment. The main controller 40, which mainly controls each of the deck inverter controllers 92a, 92b, and 92c, executes the control processing shown in FIG. 6. A program for executing the control processing shown in FIG. 6 is stored in the main controller 40 in advance. The main controller 40 may be a controller integrated with the deck inverter controllers 92a, 92b, and 92c. First, in step S10 of FIG. 6, the working unit start switch 33, which is a switch of the deck motor 63, is turned on to start lawn mowing work. Upon turning on the working unit start switch, the main controller 40 rotates each deck motor 63 at the rated rotation speed Vr (see FIG. 4), which is a set rotation speed.

Next, in step S11, it is determined whether or not it is detected that the torque of at least one of the deck motors 63 is a torque exceeding a line of the upper-limit torque decrease region β2 representing the upper-limit torque corresponding to the set rotation speed, such as the rated rotation speed Vr, of the high-load-adaptive power map, and the load on at least one of the deck motors 63 is a high load. If the determination result in step S11 is positive (YES), in step S12, the main controller 40 causes the rotation speed of the deck motor 63 to decrease so that the operation point of the deck motor 63 on which the high load acts is positioned on the upper-limit line of the high-load-adaptive power map, and performs control so that the torque of the deck motor 63 increases corresponding to an increase in the mowing load and the rotation speed of the deck motor 63 on which the high load acts decreases on the upper-limit line. For example, when it is detected that the deck motor 63 operates at the operation point c1 shown in FIG. 4, the main controller 40 causes the deck motor 63 to decrease the rotation speed thereof and to move the operation to the operation point c2. Further, the main controller 40 causes the deck motor 63 to move the operation to the operation point in the arrow a2 direction along the line of the upper-limit torque decrease region β2 to decrease the rotation speed of the deck motor 63 so that the torque corresponding to the increase in the mowing load can be obtained.

Next, in step S13, the main controller 40 causes the rotation speeds of the deck motors 63 on which a high load does not act to decrease to the same rotation speed as the deck motor 63 on which the high load acts. After step S13, the process proceeds to step S14. In step S14, the main controller 40 causes the rotation speed of the traveling motors 30 and 31 to decrease in accordance with the rate of change in the rotation speed of the deck motor 63. Specifically, the main controller 40 causes the degree of increase in the target rotation speed of the traveling motors 30 and 31 in accordance with the change in the operation positions of the operation levers 22 and 23 to decrease in accordance with the rate of decrease in the rotation speed of the deck motor 63 on which the high load acts. For example, when the rotation speed of the deck motor 63 on which the high load acts decreases by 20% from the rated rotation speed Vr, the main controller 40 causes the rotation speeds of the traveling motors 30 and 31 to decrease by 20% at the same operation positions of the operation levers 22 and 23.

Next, in step S15, the main controller 40 determines whether or not the working unit start switch 33, which is a switch of the deck motor 63, is turned off. If the determination result in step S15 is positive (YES), the main controller 40 causes all of the deck motors 63 to stop in step S19, and causes the processing to be terminated.

On the other hand, if the determination result of step S15 is negative (NO), in step S16, the main controller 40 determines whether or not the torque of at least one of the deck motors 63 exceeds the upper-limit torque Tmax (see FIG. 4) of the high-load-adaptive power map. If the determination result of step S16 is positive (YES), since an excessive load is generated in at least one of the deck motors 63 and the deck motor 63 stops in a stall state, the main controller 40 issues an emergency stop to all of the deck motors 63, including the other deck motors 63, to cause all of the deck motors 63 to stop, and causes the processing to be terminated. Thus, in the event that an excessive load is generated in at least one of the deck motors 63, all of the deck motors 63 are stopped, so that the operator can notice that the excessive load is generated in the deck motor 63 at an early stage by the change of the sound of the lawn mower 18. Therefore, it is possible to suppress the traveling from being continued with the grass left unmown, and the mowing work can be more efficiently performed.

On the other hand, if the determination result in step S16 is negative (NO), the main controller 40 causes the processing to return to step S11 and to be repeated. Furthermore, when the determination result of step S11 is negative, this is a case where a high load is not detected in any of the deck motors 63, and therefore, in step S17, the main controller 40 causes the deck motors 63 to drive rotationally at the rated rotation speed (for example, 3000 min\hat{ }−1).

Next, in step S18, similarly to step S15, the main controller 40 determines whether or not the working unit start switch 33 is turned off. If the determination result in step S18 is positive (YES), the main controller 40 causes the processing to proceed to step S19. On the other hand, if the determination result in step S18 is negative (NO), the main controller 40 causes the processing to return to step S11 and to be repeated.

According to the vehicle 10 of the above-mentioned embodiment, even if a high load acts on the deck motor 63, since a sudden stop is less likely to occur, it is possible to suppress the grass from being left unmown, and mowing work can be efficiently performed.

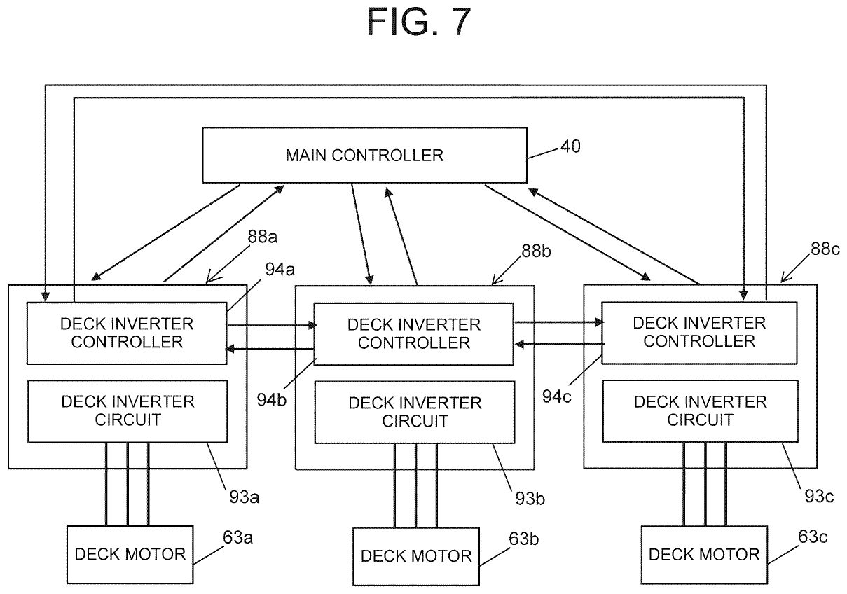

FIG. 7 is a block diagram of an electric mowing vehicle according to an alternative example of the embodiment, which corresponds to FIG. 3B. In the configuration of the present example, unlike the configuration shown in FIG. 3B, a part of the control processing is executed among the plurality of deck inverter controllers 94a, 94b, and 94c without interposing the main controller 40. For this reason, each of the plurality of deck inverter controllers 94a, 94b, and 94c is connected to the remaining two of the deck inverter controllers 94a, 94b, and 94c via signal lines to enable input and output of signals. Furthermore, a high-load-adaptive power map is stored in advance in the storage section of each of the deck inverter controllers 94a, 94b, and 94c, and the detected torque and the detected rotation speed of the deck motor 63 of interest are input to any of the deck inverter controllers 94a, 94b, and 94c. Furthermore, each of the deck inverter controllers 94a, 94b, and 94c detects that the load on the deck motor 63 is high when the detected torque corresponding to the rotation speed of the deck motor 63 of interest exceeds the upper-limit torque corresponding to the rotation speed of the deck motor 63 in the high-load-adaptive power map. When it is detected that the load on the deck motor 63 is high, the corresponding one of the deck inverter controllers 94a, 94b, and 94c executes the high-load-adaptive control to cause the deck motor 63 on which the high load acts to operate in accordance with the high-load-adaptive power map. In the present example, the plurality of deck inverter controllers 94a, 94b, and 94c correspond to a controller that mainly executes the high-load-adaptive control.

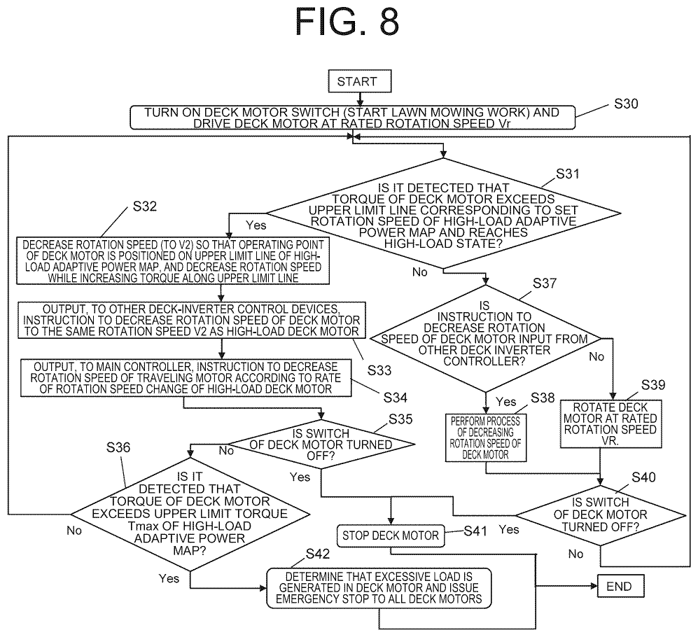

FIG. 8 is a flowchart showing an example of a method of controlling the deck motors 63 according to the alternative embodiment. A program for executing the control processing of FIG. 8 is stored in advance in the storage section of each of the deck inverter controllers 94a, 94b, and 94c. First, in step S30 of FIG. 8, the working unit start switch 33, which is a switch of the deck motor 63, is turned on to start lawn mowing work, and each of the deck inverter controllers causes each of the deck motors 63 to be rotationally driven at the rated rotation speed Vr. At this time, an ON signal of the working unit start switch 33 may be input to the deck inverter controllers via the main controller 40.

Next, in step S31, each of the deck inverter controllers 94a, 94b, and 94c determines whether the detected torque of the deck motor 63 corresponding thereto is a torque exceeding the line of the upper-limit torque decrease region β2 representing the upper-limit torque corresponding to the set rotation speed of the high-load-adaptive power map and whether it is detected that the load on at least one of the deck motors 63 is high. If the determination result in step S31 is positive (YES), in step S32, the corresponding one of the deck inverter controllers 94a, 94b, and 94c causes the rotation speed of the deck motor 63 of interest to decrease so that the operation point of the deck motor 63 on which a high load acts is positioned on the upper-limit line of the high-load-adaptive power map, and then causes the torque thereof to increase in response to an increase in the mowing load and causes the rotation speed of the deck motor 63 on which the high load acts to decrease, on the upper-limit line of the high-load-adaptive power map.

Next, in step S33, the corresponding one of the deck inverter controllers 94a, 94b, and 94c sends, to the other deck inverter controllers 94a, 94b, and 94c, an instruction to cause the rotation speeds of the deck motors 63 corresponding to the other deck inverter controllers 94a, 94b, and 94c to decrease to the same rotation speed as that of the deck motor 63 on which a high load acts. In response to the instruction, as described later, the other deck inverter controllers 94a, 94b, and 94c cause the rotation speeds of the deck motors 63 corresponding to the other deck inverter controllers 94a, 94b, and 94c to decrease to the rotation speed indicated by the instruction.

Next, in step S34, each of the deck inverter controllers 94a, 94b, and 94c sends, to the main controller 40, an instruction to cause the rotation speeds of the traveling motors 30 and 31 to decrease in accordance with the rate of change in the rotation speed of the deck motor 63 of interest. Specifically, each of the deck inverter controllers 94a, 94b, and 94c sends, to the main controller 40, an instruction to cause the degree of an increase in the target rotation speeds of the traveling motors 30 and 31 in accordance with the change in the operation positions of the operation levers 22 and 23 to decrease in accordance with the rate of decrease in the rotation speed of the deck motor 63 on which a high load acts. In response to the instruction, the main controller 40 causes the rotation speeds of the traveling motors 30 and 31 to decrease to the rotation speed indicated by the instruction.

Next, in step S35, any one of the deck inverter controllers 94a, 94b, and 94c determines whether the working unit start switch 33, which is a switch of the deck motor 63, is turned off. If the determination result of S35 is positive (YES), any one of the deck inverter controllers 94a, 94b, and 94c causes the deck motor 63 corresponding thereto to be stopped in step S41 and causes the processing to be terminated.

On the other hand, if the determination result of step S35 is negative (NO), in step S36, the corresponding one of the deck inverter controllers 94a, 94b, and 94c determines whether the detected torque of the deck motor 63 of interest exceeds the upper-limit torque Tmax of the high-load-adaptive power map. If the determination result of S36 is positive (YES), since an excessive load is generated in at least one of the deck motors 63 and the deck motor 63 of interest is stopped in a stall state, the corresponding one of the deck inverter controllers 94a, 94b, and 94c issues, to the other deck inverter controllers 94a, 94b, and 94c, an instruction to cause the deck motors 63 corresponding to the other deck inverter controllers 94a, 94b, and 94c to be stopped so as to stop all of the deck motors 63 in an emergency, and causes the processing to be terminated.

On the other hand, if the determination result in step S36 is negative (NO), the deck inverter controllers 94a, 94b, and 94c cause the processing to return to step S31 and to be repeated. If the determination result of step S31 is negative (NO), it is determined in step S37 whether an instruction to cause the rotation speed of the deck motor 63 to decrease is input from the other deck inverter controllers 94a, 94b, and 94c.

If the determination result in step S37 is positive (YES), in step S38, each of the deck inverter controllers 94a, 94b, and 94c causes the rotation speed of the deck motor 63 corresponding to each of the deck inverter controllers 94a, 94b, and 94c to decrease to the rotation speed indicated by the instruction, that is, the same rotation speed as the rotation speed of the deck motor 63 on which the high load acts.

On the other hand, if the determination result in step S37 is negative (NO), in step S39, each of the deck inverter controllers 94a, 94b, and 94c rotationally drives the deck motor 63 corresponding to each of the deck inverter controllers 94a, 94b, and 94c at the rated rotation speed.

After the processing of S38 and S39 is finished, in step S40, it is determined whether the working unit start switch 33 is turned off. If the determination result of S40 is positive (YES), in step S41, any one of the deck inverter controllers 94a, 94b, and 94c causes the deck motor 63 corresponding to any one of the deck inverter controllers 94a, 94b, and 94c to be stopped, and causes the processing to be terminated.

On the other hand, when the result of the determination in step S40 is negative (NO), the deck inverter controllers 94a, 94b, and 94c cause the processing to return to step S31, and cause the processing to be repeated.

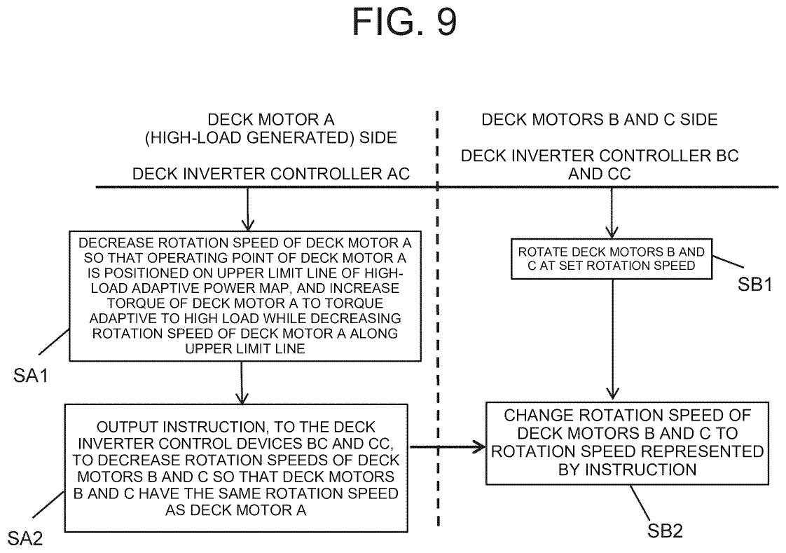

FIG. 9 is a diagram showing a part of the processing of the plurality of deck inverter controllers 94a, 94b, and 94c when causing the plurality of deck inverter controllers 94a, 94b, and 94c to execute the control processing of FIG. 8. FIG. 9 shows a case where the deck motor 63 is divided into deck motors A, B, and C, and a high load acts on the deck motor A. Furthermore, a description of the deck inverter controllers 94a, 94b, and 94c is given in such a manner that the deck inverter controllers are separated into a deck inverter controller CA for controlling the deck motor A and deck inverter controllers CB and CC for controlling the deck motors B and C. Note that when a high load acts on two deck motors 63 simultaneously, for example, the deck motors A and B are on the high load generated side, and the deck motor C is on the high load ingenerated side.

According to the execution of the control method of the present example, as shown in SA1 of FIG. 9, when it is detected that the load on the deck motor A is high, the deck inverter controller CA controls the operation to cause the rotation speed of the deck motor A to decrease so that the operation point of the deck motor A is positioned on the upper-limit line of the high-load-adaptive power map, to cause the torque of the deck motor A to increase in response to the increase in the mowing load on the upper-limit line, and to cause the rotation speed of the deck motor 63 on which a high load acts to decrease.

Next, the deck inverter controller CA sends an instruction to the other deck inverter controllers BC and CC to decrease the rotation speeds of the other deck motors B and C to be the same as the rotation speed of the deck motor A.

On the other hand, the deck inverter controllers BC and CC on the deck motors B and C side, on which a high load does not act, control the operation of the deck motors B and C to cause the deck motors B and C to rotate at the rated rotation speed, which is the set rotation speed, until the deck inverter controllers BC and CC receive the instruction from another deck inverter controller CA. As shown in SB2 of FIG. 9, when the deck inverter controllers BC and CC receive the instruction to decrease the rotation speeds of the deck motors B and C from the deck inverter controller CA, the deck inverter controllers BC and CC control the operation of the deck motors B and C to cause the rotation speeds of the deck motors B and C to be changed to the rotation speeds indicated by the instruction. In the present example, other configurations and actions are the same as those shown in FIG. 1 to FIG. 6.

Note that in the above-mentioned embodiment, the case where the upper-limit torque value linearly decreases as the rotation speed increases in the upper-limit torque decrease region in the high-load-adaptive power map is described. However, the upper-limit torque value may decrease curvedly as the rotation speed increases in the upper-limit torque decrease region.

Furthermore, in the above-mentioned embodiment, a description is given as an example that the lawn mower 18 includes the three deck motors 63 and the three lawn mowing blades 18a, 18b, and 18c, which are driven by the three deck motors 63, respectively. However, the number of each of the lawn mowing motors and the lawn mowing blades may be two, four, or more.

Furthermore, in the above-mentioned embodiment, the left and right wheels can be driven independently of each other, the left wheel is driven by the left electric motor, and the right wheel is driven by the right electric motor. The present invention can also be applied to a vehicle in which the left and right wheels are driven in common by an electric motor.

The present disclosure is further described by the following embodiments. Configuration 1: An electric mowing vehicle comprising: a mowing machine; and a controller, wherein the mowing machine includes: a plurality of mowing motors that are electric motors for mowing and mowing blades driven by each of the plurality of mowing motors. The controller executes a high-load-adaptive control to cause a mowing motor on which a high load acts to operate in accordance with a high-load-adaptive power map that defines a relationship between an upper-limit torque value that can be output by the mowing motor and a rotation speed of the mowing motor when it is detected that a load on at least one of the plurality of mowing motors is high, and a boundary rotation speed of the mowing motor in the high-load-adaptive power map, at a time when switching from an upper-limit torque constant region, in which the upper-limit torque value is constant regardless of the rotation speed of the mowing motor, to an upper-limit torque decrease region, in which the upper-limit torque value decreases in accordance with an increase in the rotation speed of the mowing motor, is defined to be lower than an upper-limit rotation speed of the upper-limit torque constant region in a power characteristic of the mowing motor that is determined by the type of the mowing motor and a maximum voltage that can be applied to the mowing motor in a case where the high-load-adaptive control is not executed.

Configuration 2: The electric mowing vehicle according to Configuration 1, wherein the boundary rotation speed is set to be substantially equal to a minimum rotation speed of the mowing motor that is required for mowing work using the mowing blades.

Configuration 3: The electric mowing vehicle according to Configuration 1, wherein a lower-limit torque of the upper-limit torque decrease region is 65% or more and 75% or less of a torque value of the upper-limit torque constant region.

Configuration 4: The electric mowing vehicle according Configurations 1, wherein the controller detects that the load on the mowing motor is high when a detected torque in accordance with the rotation speed of at least one mowing motor exceeds the upper-limit torque corresponding to the rotation speed of the mowing motor in the high-load-adaptive power map.

Configuration 5: The electric mowing vehicle according to Configurations 1, wherein when a high load acts on a part of the plurality of mowing motors, the controller causes the torque of the mowing motor to increase and causes the rotation speed of the mowing motor to decrease according to the high-load-adaptive power map, and the controller causes the rotation speeds of the remaining mowing motors on which the high load does not act to match the rotation speed of the mowing motor on which the high load acts.

Configuration 6: The electric mowing vehicle according to Configurations 1, further comprising: a traveling motor to drive a wheel; and an operation tool for instructing a target rotation speed of the traveling motor by an operation position, wherein the controller controls the driving of the traveling motor in accordance with the target rotation speed, and when it is detected that the load on at least one of the plurality of mowing motors is high, the controller causes the torque of the mowing motor to increase and causes the rotation speed of the mowing motor to decrease in accordance with the high-load-adaptive power map, and the controller causes the degree of increase in the target rotation speed of the traveling motor in accordance with a change in the operation position to decrease in accordance with the rate of decrease in the rotation speed of the mowing motor on which the high load acts.

Configuration 7: The electric mowing vehicle according to Configuration 6, wherein when the state changes from a state where a high load acts on at least one of the plurality of mowing motors to a state where the high load acts on none of the plurality of mowing motors, the controller causes the rotation speeds of all of the mowing motors to return to normal rotation speeds and causes the degree of increase in the target rotation speed of the traveling motor corresponding to the change in the operation position of the operation tool to return to a normal degree.

### REFERENCE SIGNS LIST

10 Electric mowing vehicle (vehicle)
12 Left wheel
13 Right wheel
15, 16 Caster wheel
18 Lawn mower
18a, 18b, 18c Lawn mowing blade
18d Discharge duct
19 Mower deck
20 Main frame
20a, 20b Side plate portion
20c Coupling portion
21 Driver's seat
22, 23 Operation lever
24 Grip portion
26, 27 Guide panel
30 Left traveling motor
31 Right traveling motor
32 Operation unit
33 Working unit start switch
34 Battery
35 Start switch
40 Main controller
50, 51 Lever position sensor
52 Deck motor speed sensor
54 Left motor speed sensor
55 Right motor speed sensor
63a, 63b, 63c Deck motor
80 Control system
80a Left gear mechanism
80b Right gear mechanism
84 Left traveling inverter
86 Right traveling inverter
88a, 88b, 88c Deck inverter
90 Current detector
91 Torque calculation unit
92a, 92b, 92c, 94a, 94b, 94c Deck inverter controller
93a, 93b, 93c Deck inverter circuit
120, 121 Axle

1. A mowing vehicle comprising: a mowing machine; and a controller, wherein
the mowing machine includes:
a plurality of mowing motors that are electric motors for mowing and mowing blades driven by the plurality of mowing motors,
The controller executes a high-load-adaptive control to cause a mowing motor on which a high load acts to operate in accordance with a high-load-adaptive power map that defines a relationship between an upper-limit torque value that can be output by the mowing motor and a rotation speed of the mowing motor when it is detected that a load on at least one of the plurality of mowing motors is high, and
a boundary rotation speed of the mowing motor in the high-load-adaptive power map, at a time when switching from an upper-limit torque constant region, in which the upper-limit torque value is constant regardless of the rotation speed of the mowing motor, to an upper-limit torque decrease region, in which the upper-limit torque value decreases in accordance with an increase in the rotation speed of the mowing motor, is defined to be lower than an upper-limit rotation speed of the upper-limit torque constant region in a power characteristic of the mowing motor that is determined by the type of the mowing motor and a maximum voltage that can be applied to the mowing motor in a case where the high-load-adaptive control is not executed.

2. The mowing vehicle according to claim 1, wherein
the boundary rotation speed is set to be substantially equal to a minimum rotation speed of the mowing motor that is required for mowing work using the mowing blades.

3. The mowing vehicle according to claim 1, wherein
a lower-limit torque of the upper-limit torque decrease region is 65% or more and 75% or less of a torque value of the upper-limit torque constant region.

4. The mowing vehicle according to claim 1, wherein
the controller detects that the load of the mowing motor is high when a detected torque in accordance with the rotation speed of the at least one mowing motor exceeds an upper-limit torque corresponding to the rotation speed of the mowing motor in the high-load-adaptive power map.

5. The mowing vehicle according to claim 1, wherein
when a part of the plurality of mowing motors is subject to a high load, the controller causes a torque of the mowing motor to increase and causes the rotation speed of the mowing motor to decrease according to the high-load-adaptive power map, and the controller causes the rotation speeds of remaining mowing motors not subject to a high load to match with the rotation speed of the mowing motor subject to a high load.

6. The mowing vehicle according to claim 1 further comprising:
a traveling motor to drive a wheel; and
an operation tool for instructing a target rotation speed of the traveling motor by an operation position, wherein
the controller controls the driving of the traveling motor in accordance with the target rotation speed, and when it is detected that the load on at least one of the plurality of mowing motors is high, the controller causes the torque of the mowing motor to increase and causes the rotation speed of the mowing motor to decrease in accordance with the high-load-adaptive power map, and the controller causes the degree of increase in the target rotation speed of the traveling motor in accordance with a change in the operation position to decrease in accordance with the rate of decrease in the rotation speed of the mowing motor on which the high load acts.

7. The mowing vehicle according to claim 6, wherein
when the state changes from a state where a high load acts on at least one of the plurality of mowing motors to a state where the high load acts on none of the plurality of mowing motors, the controller causes the rotation speeds of all of the mowing motors to return to normal rotation speeds and causes the degree of increase in the target rotation speed of the traveling motor corresponding to the change in the operation position of the operation tool to return to a normal degree.
